(19) United States
(12) Patent Application Publication
(10) Pub. No.: US 2006/0253299 A1
(43) Pub. Date: Nov. 9, 2006

(54) Hospital information system

(76) Inventors: Nakao Konishi, Hiroshima-shi, Hiroshima (JP); Kunio Suganuma, Tokyo (JP)

Correspondence Address: PHILIPS INTELLECTUAL PROPERTY & STANDARDS, 595 MINER ROAD, CLEVELAND, OH, 44143, US

(21) Appl. No.: 10/558,340

(22) PCT Filed: May 28, 2004
(86) PCT No.: PCT/IB04/50797

§ 371 Date: Nov. 23, 2005

(30) Foreign Application Priority Data
May 28, 2003 (WO) PCT/IB03/02050

(51) Int. Cl. G06Q 10/00

(52) U.S. Cl. 705/2

(57) ABSTRACT

In a hospital information system of the present invention, it is possible to link between certificated indication contents and implementation result on a flow sheet (a sheet displaying timevarying vital signs, Intake/Output, observations, and measures) by linking doctor's indications between an indication sheet and a flow sheet, which is mainly used by nurses. It is possible to input the time-varying used amount on the flow sheet after nurses receive the indication, as well as the indication by the doctor. It is also possible to transmit the medical amount billed on the basis of administration amounts to other system automatically, by calculating the unit price or the medical amount billed on the basis of the used amount.

### TECHNICAL FIELD

The present invention relates to a hospital information system, in particular, to a hospital information system, which is able to correspond with changes of medical treatments corresponding to the condition of a disease of patients.

### BACKGROUND ART

Conventionally, an information system is used in hospitals. This information system is a system for supporting overall operations in a hospital such as first visit reception, inpatient reception, outpatient consultation, ward management, medical matters section, pharmacy section, material section and inspection section. When functions supporting inpatient operations are divided into clinical functions and management functions, operation support functions concerning medicines such as injections and transfusions out of clinical operations required for a computer system vary a great among acute stages such as ICU/NICU or between wards for seriously ill patients and general wards.

In general wards, a necessary amount of medicine used on a daily basis is ordered from a pharmacy section in specified units such as bottles or ampoules. The order is also accompanied by clinical indications from a doctor to nurses such as composition of medicines used (concentration, used amount, etc.), administration rate (ml/h, μg/kg/min) per unit time, route, regions and other precautions, etc.

Several hospitals adopts a system designed to regard medicine as have already been used the moment the order is received and proceed with medical accounting processing. Furthermore, many hospitals fill out used amounts in paper injection slips or prescription slips and submit them to their medical matters section. Moreover, medicines actually not used (not opened) are supposed to be sent back to the pharmacy section with a return slip, etc., attached thereto.

In the case of general wards, conditions of their patients are relatively stable and ordering a necessary amount of medicine used on a daily basis would cause no considerable inconvenience. Therefore, many vendors of a hospital information system basically provide an ordering function and medical accounting function similar to those in general wards for also acute stages such as ICU/NICU and wards for seriously ill patients.

However, in acute stages or wards for seriously ill patients, conditions of patients may drastically change or emergency patients are carried in, and therefore indication contents by a doctor are also frequently changed. For this reason, it is necessary to support indication contents which are frequently changed, characteristic of an acute stage, but no hospital information system with such a function exists yet.

### DISCLOSURE OF INVENTION

### Technical Solution

It is an object of the present invention to provide a hospital information system, which is able to speedily correspond with changes of medical treatments corresponding to the condition of a disease of patients.

In a hospital information system of the present invention, it is possible to link between certificated indication contents and implementation result on a flow sheet (a sheet displaying time-varying vital signs, Intake/Output, observations, and measures) by linking doctor's indications between an indication sheet and a flow sheet, which is mainly used by nurses.

That is, since the indication sheet is linked with the flow sheet, the flow sheet is updated with information on the indication sheet in real time, and inversely the indication sheet is updated with information on the flow sheet in real time. This makes it possible to correctly transmit necessary information on the indication sheet to the nurses who are working mainly by observing the flow sheet. In this way, it is possible to implement a hospital information system which is able to speedily correspond with changes of medical treatments corresponding to the condition of a disease of patients.

Furthermore, various hospitals have an established ordering system for ordering medicines, but medical accounting processing on medicines is often realized based on paper such as injection slips and prescription slips. This medical accounting processing on medicines is preferably carried out based on an actual administration amount and from the standpoint of efficient recording operations on the clinical work fronts, there is a demand, as an ideal form, for a function of calculating a medical accounting unit price such as the number of bottles and ampoules actually used based on time-varying records called a ‘flow sheet’ and automatically sending the amount to be used to a medical matters section system.

In the hospital information system of the present invention, it is also possible to input the time-varying used amount on the flow sheet after nurses receive the indication, as well as the indication by the doctor. It is also possible to transmit the medical amount billed on the basis of administration amounts to the medical matters section system automatically, by calculating the unit price or the medical amount billed on the basis of the used amount for both shot-based medicines and persistent medicines.

The hospital information system of the present invention comprises display means for electronic displaying an indication sheet displayed at least an indication content of a doctor and a flow sheet displayed at least time-varying vital sign, time-varying observation and time-varying treatment on a screen, information registration means for managing information displayed on the indication sheet and information displayed on the flow sheet and controlling means for updating the flow sheet with information inputted on the indication sheet and for updating the indication sheet with information inputted on the flow sheet.

According to this construction, it is possible to link between certificated indication contents and implementation result on a flow sheet (a sheet displaying time-varying vital signs, Intake/Output, observations, and measures) by linking doctor's indications between an indication sheet and a flow sheet, which is mainly used by nurses. In this way, it is possible to implement a hospital information system which is able to speedily correspond with changes of medical treatments corresponding to the condition of a disease of patients.

In the hospital information system of the present invention, the doctor preferably provides an indication on the indication sheet, a nurse receives the indication and/or implements the indication on the flow sheet,

In the hospital information system of the present invention, it is preferable to further comprise unit price calculating means for calculating a unit price on the basis of an amount of a used medicine after the nurse's implementing the indication.

In the hospital information system of the present invention, it is preferable to further comprise medical amount billed calculating means for calculating a medical amount billed of a medicine on the basis of the amount of a used medicine or the unit price.

These constructions make it possible to calculate the amount of medicine and medical amount billed which become basic data for medical accounting on the basis of implementation records. This reduces the amount of counting processing which used to be complicated. This makes processing electronic, and can thereby prevent mix-ups between slips, etc. This also eliminates the need for conventional double recording on indication sheets and slips and improves the efficiency of operations. Moreover, since medicines are requested based on information of an accurate used amount after implementation, it is possible to improve the efficiency of inventory management.

In the hospital information system of the present invention, an indication of requesting an article included in the indication is preferably transmitted to the other system corresponding to the input of the indication by the doctor.

According to this construction, the indication sheet is linked with the flow sheet, and therefore the flow sheet is updated with the indication by the doctor in real time. Here, the information on the indication sheet reflected in the flow sheet is basically information necessary for the nurses to observe on the flow sheet. For example, when a administration rate is changed, the flow sheet is updated with a new administration rate. This allows the latest indication content to be transmitted to the nurses correctly.

Furthermore, such a construction allows requested articles including medicine to be changed speedily. Furthermore, since the flow sheet can be updated with changes in the indication by the doctor in real time, it is possible to adopt a procedure for billing the medicine actually used after implementation and thereby prevent useless billing.

In the hospital information system of the present invention, a new indication or a change of the indication inputted by the doctor on the indication sheet is preferably displayed on the flow sheet.

In the hospital information system of the present invention, order information received from the other system is preferably taken in and displayed on the indication sheet and/or the flow sheet.

### DESCRIPTION OF DRAWINGS

FIG. 1 is a view showing a diagrammatic construction of a hospital information system according to an embodiment of the present invention;

FIG. 2 is a view showing an indication sheet used in a hospital information system according to an embodiment of the present invention;

FIG. 3 is a view showing a flow sheet used in a hospital information system according to an embodiment of the present invention;

FIG. 4 is a block diagram showing a diagrammatic construction of a hospital information system managing center in a hospital information system according to an embodiment of the present invention;

FIG. 5 is a block diagram showing a diagrammatic construction of PCs in a hospital information system according to an embodiment of the present invention;

FIG. 6 is a view showing a construction of an indication sheet used in a hospital information system according to an embodiment of the present invention;

FIG. 7 is a view showing an indication sheet used in a hospital information system according to an embodiment of the present invention;

FIG. 8 is a view showing an indication sheet used in a hospital information system according to an embodiment of the present invention;

FIG. 9 is a view illustrating a preset function of a hospital information system according to an embodiment of the present invention;

FIG. 10 is a view illustrating a preset function of a hospital information system according to an embodiment of the present invention;

FIG. 11 is a view showing a flow sheet in a hospital information system according to an embodiment of the present invention;

FIG. 12 is a view showing an input screen at the end of a transfusion in the flow sheet shown in FIG. 11;

FIG. 13 is a view showing a flow sheet in a hospital information system according to an embodiment of the present invention;

FIG. 14 is a flow chart illustrating a procedure until an indication is received in a hospital information system according to an embodiment of the present invention; and

FIG. 15 is a flow chart illustrating a procedure after an indication is received until the indication is implemented in a hospital information system according to an embodiment of the present invention.

### MODE FOR INVENTION

With reference now to the attached drawings, embodiments of the present invention will be explained in detail below.

FIG. 1 is a view showing a diagrammatic construction of a hospital information system according to an embodiment of the present invention. This hospital information system is mainly constructed of a hospital information system managing center 11 and PCs 12 connected to this managing center. Furthermore, this hospital information system managing center 11 is also connected to another system 13 such as ordering system, accounting system as required.

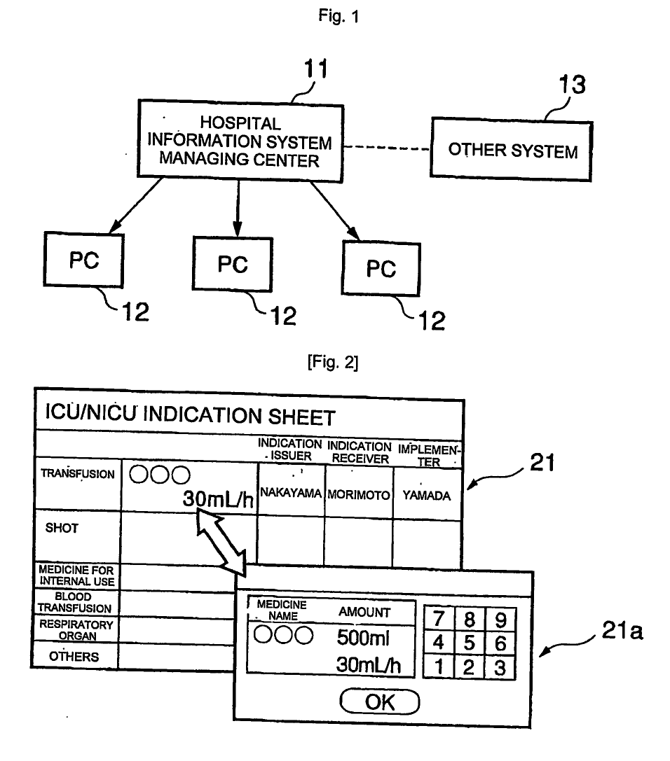

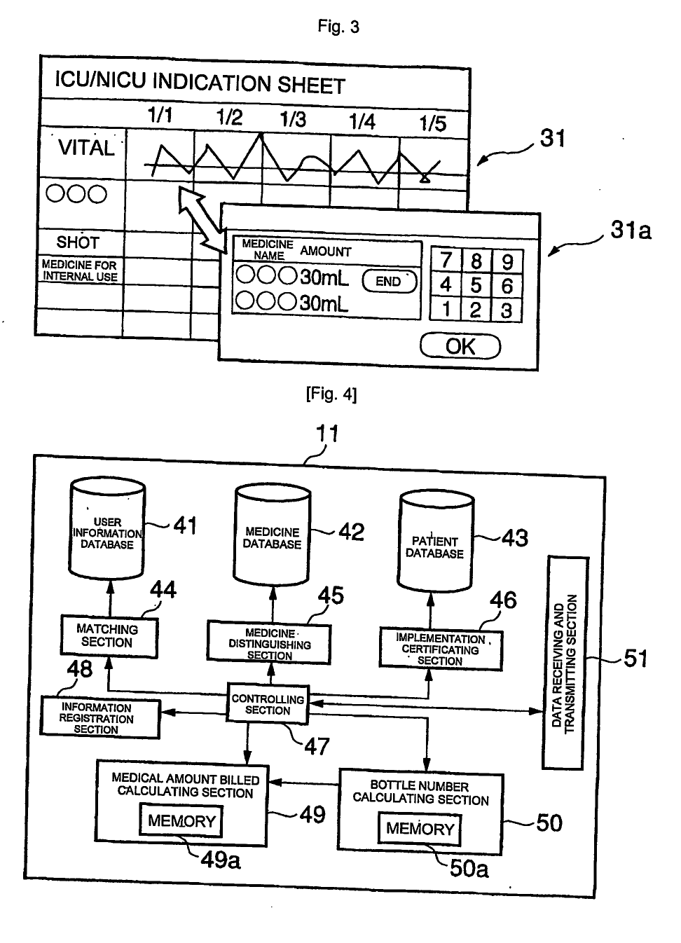

In this hospital information system, an indication sheet 21 shown in FIG. 2 which is mainly used by a doctor and a flow sheet 31 shown in FIG. 3 mainly used by nurses are displayed on a screen to receive indications by a certificated doctor or certificated nurses and inputted medical practices implemented. The information inputted on any one of screens is reflected on other screens.

For example, as shown in FIG. 2, when a doctor clicks on the item on the indication sheet 21, a transfusion input screen 21a is displayed on the same screen. On the screen, the doctor inputs a medicine name, administration amount, administration rate, administration time (start and administration period), administration count and region of administration. When entries are completed, the indication sheet 21 displays the name of the doctor who provided the indication in the indication issuer field and the medicine name, administration amount and administration rate are displayed in the item of transfusion. The name of the doctor who provided the indication, administration amount and administration rate are reflected in the flow sheet 31. Furthermore, when a certificated nurse receives an indication on the indication sheet 21 and makes an entry, the name of the nurse who has received the indication is displayed in the indication reception field of the indication sheet 21. Here, the indication reception refers to the response by the nurse indicating that the nurse has confirmed the indication content, and so indications not responded by the nurse are not reflected in the flow sheet.

In the flow sheet 31, when the administration of the indicated medicine is completed, the certificated nurses makes an entry in the flow sheet 31 indicating that the administration has been completed. For example, when the nurse clicks on a administration mark in the flow sheet 31 reflected from the indication sheet 21, an input screen 31a is displayed on the same screen and the nurse clicks on the end button. This causes the information of administration completion to be reflected in the indication sheet 21. Then, the name of the nurse who dosed (implemented) is displayed in the field of the implementer of the indication sheet 21.

The hospital information system managing center 11 has a construction as shown in FIG. 4. FIG. 4 is a block diagram showing a diagrammatic construction of a hospital information system managing center in a hospital information system according to an embodiment of the present invention.

The hospital information system managing center 11 is provided with a user information database (DB) 41 which stores information on an indication issuer who provides an indication, an indication receiver who receives the indication, a system user such as an implementer who implements medical practices, for example, a doctor or nurse, a medicine database (DB) 42 which stores information on a medicine administered to a patient or a medicine used for treatment of the patient and a patient database (DB) 43 which stores information on the patient. Each database is designed to be updated by registering or deleting information as appropriate.

The hospital information system managing center 11 includes a matching section 44 which compares information on a person who makes an entry in the system with user information, a medicine distinguishing section 45 which distinguishes a medicine to be used as a shot medicine from a medicine to be used as a persistent medicine, an implementation certificating section 46 which certificates whether an indicated medicine can be administered to the patient or not, an information registration section 48 which registers information on an indication sheet or flow sheet displayed on a screen, a medical amount billed calculating section 49 which calculates medical amount billed corresponding to the indicated medicine, a bottle number calculating section 50 which calculates the indicated medicine in bottle number units, a data receiving and transmitting section 51 which receives and transmits data from/to each PC 12 and a controlling section 47 which controls the entire system.

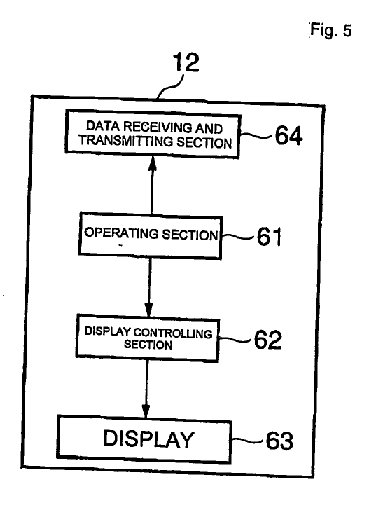

The PC 12 has a construction shown in FIG. 5. FIG. 5 is a block diagram showing a diagrammatic construction of PCs in the hospital information system according to this embodiment of the invention. The PC 12 mainly includes an operating section 61 which performs various inputs to the system, a display controlling section 62 which controls information acquired from the hospital information system managing center 11 so as to be displayed on an indication sheet or flow sheet and a display 63 which displays the indication sheet or flow sheet, etc.

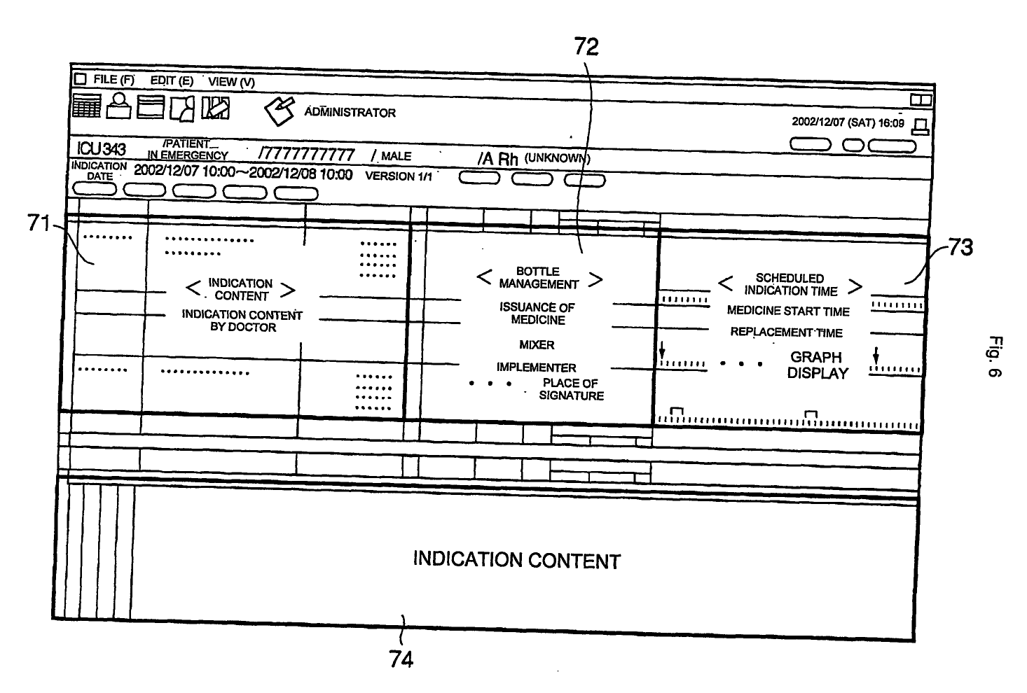

In the hospital information system of the present invention, the following functions will be realized by displaying an indication sheet and flow sheet on a screen of the PC 12 and making an entry in the indication sheet and/or flow sheet. Here, the functions will be explained using specific screens of the indication sheet and flow sheet (FIG. 6 to FIG. 8 and FIG. 10 to FIG. 13). Furthermore, the functions will also be explained using FIG. 4 and FIG. 5 as required.

FIG. 6 is a view showing a construction of an indication sheet used in the hospital information system according to this embodiment of the invention. The indication sheet includes an indication content area 71 which displays an indication content by a doctor, a bottle managing area 72 which displays, issuance of a medicine, mixer, implementer and signature (input for conformation), a scheduled indication time area 73 which displays a medicine start time or replacement time in a graph and a specific indication content area 74 which displays a specific indication content The layout of these areas 71 to 74 is not limited to that shown in FIG. 6 but can be modified in various ways. Furthermore, the display content can also be modified in various ways.

(1) A Function of Electronically Sending an Order for a Necessary Medicine within a Certain Period of Time (One Day) when a Clinical Indication Content is Input to an Indication Sheet and an Indication Reception Function of Displaying that the Indication has been Confirmed

When a doctor inputs an indication content (indication issuance and indication reception) to the indication sheet displayed on the PC 12 using the operating section 61, the data is passed from the data receiving and transmitting section 64

through the data receiving and transmitting section 51 of the hospital information system managing center 11 and registered in the information registration section 48. Here, the registration in the information registration section 48 refers to managing/storing information to be displayed on the indication sheet and flow sheet. The information can be updated as appropriate and the update results are reflected in the indication sheet and flow sheet. At this time, the indication includes necessary clinical indications such as a administration method, for actually administering the medicine to the patient, manipulation, rate, concentration.

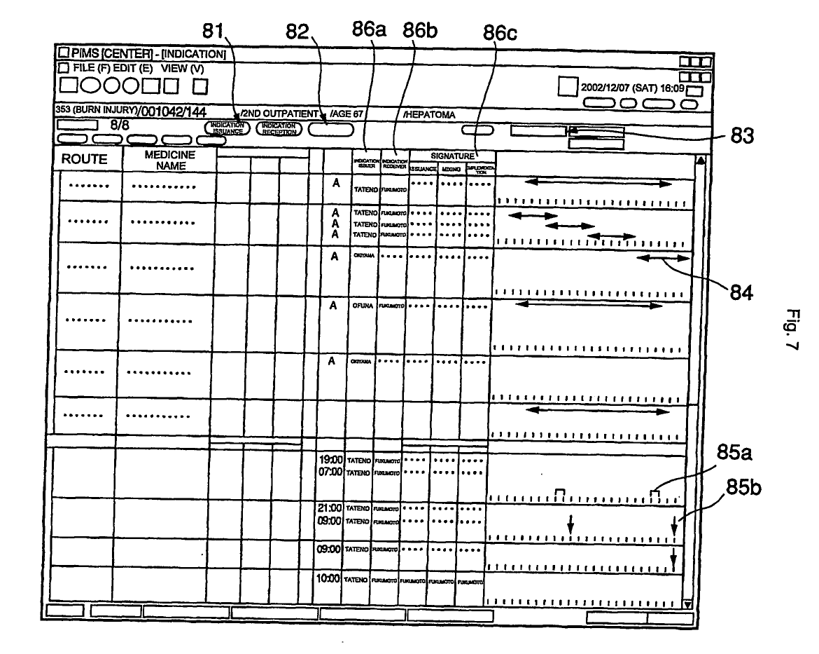

FIG. 7 is a view showing an indication sheet used in the hospital information system according to this embodiment of the invention.

When issuing an indication or changing an indication, the doctor clicks on an indication issuing button 81 on the indication sheet. At this time, the indication content input screen (FIG. 2) is displayed and the doctor inputs an indication to the input screen. This indication includes clinical indications such as the name, a administration method, manipulation, rate, concentration of the medicine actually administered to the patient. The name, etc., of the doctor who provides the indication is also input. This causes the input name to be displayed in an indication issuer field 86a of the bottle managing area of the indication sheet.

After the unit bottle number, etc., is calculated as required, the indication content by the doctor is sent to a medicine ordering system. This assumes mixing at a central pharmacy section at an indicated time or extraction from medicines in storage in the section at an indefinite time or in emergency. This allows an issuance order (article request) to be made electronically according to a medication indication for a transfer of the medicine. When issuance is carried out based on the issuance order, if the issuance area of the bottle managing area of the indication sheet is clicked, an input screen is displayed and the name of the person who issued the medicine is entered. This causes the name inputted to a signature field 86c for issuance of the bottle managing area of the indication sheet to be displayed.

Furthermore, the administration method and administration time in this indication, etc., are marked in the scheduled indication time area of the indication sheet. For example, when a medicine to be administered to the patient is a transfusion which is a persistent medicine (administered slowly for several hours), the start time and administration period are indicated and a scheduled implementation period 84 is shown by a line.

On the other hand, when the medicine to be administered to the patient is an injection which is a shot-based medicine (administered at a certain time or for a short period of time), the start time is indicated and implementation times 85a (short period) and 85b (one shot) are indicated with marks.

Furthermore, the order information issued from the system is taken in through the data receiving and transmitting section 51 and this order information is transferred to the PC 12 and reflected in the indication sheet on the display 63. When the information output from the system is transferred, a message button 83 is displayed and when the message button 83 is clicked, a screen for taking in the information is displayed. By checking the information taken in on the screen and making an entry for confirmation, the information is updated in the information registration section and displayed on the indication sheet as required. This makes it possible to recognize the order information from the system on the indication sheet,

Furthermore, when indication reception is performed which indicates that a new indication or indication change by the doctor has been confirmed, the person who performs the indication reception (e.g., nurse) clicks on an indication reception button 82. At this time, an indication reception input screen is displayed and the nurse makes an indication reception entry in the input screen. Furthermore, the nurse inputs the name of the person who performs indication reception. This causes the name inputted to be displayed in a indication reception field 86b of the bottle managing area of the indication sheet. Furthermore, when an indication of the doctor is implemented, the name of the implementer is displayed in the implementer field of the bottle managing area of the indication sheet. This implementation is reflected in the indication sheet when the implementer inputs the name in the flow sheet after normal implementation.

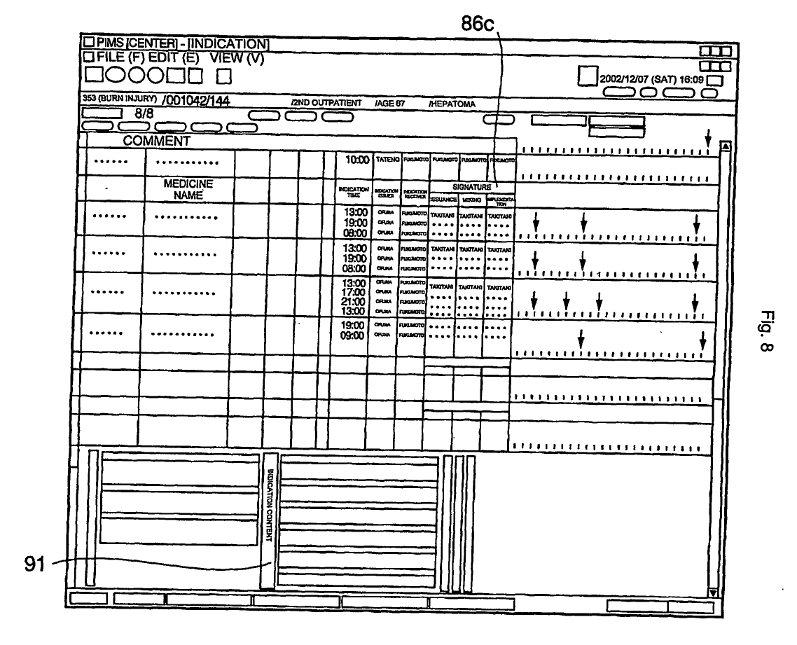

In this indication sheet, it is possible to reflect the order information such as prescription, nourishment, milk and meal (including scheduled implementation time and other indications related to implementation) issued in the hospital information system. That is, when the order information is updated at the information registration section 48, the information is developed onto the indication sheet from the data receiving and transmitting section 64 of the PC 12 through the data receiving and transmitting section 51. This allows clinical indications to be added to the indication sheet. Furthermore, it is also possible to input a specific indication content 91 in the indication sheet as shown in FIG. 8. For example, a doctor call (informed to the doctor when the condition of the patient becomes XX) and precautions, etc., are input. This makes it possible to grasp detailed indication contents from the indication sheet.

(2) Function of Outputting Medicine History Management Information and Order Cancellation Information

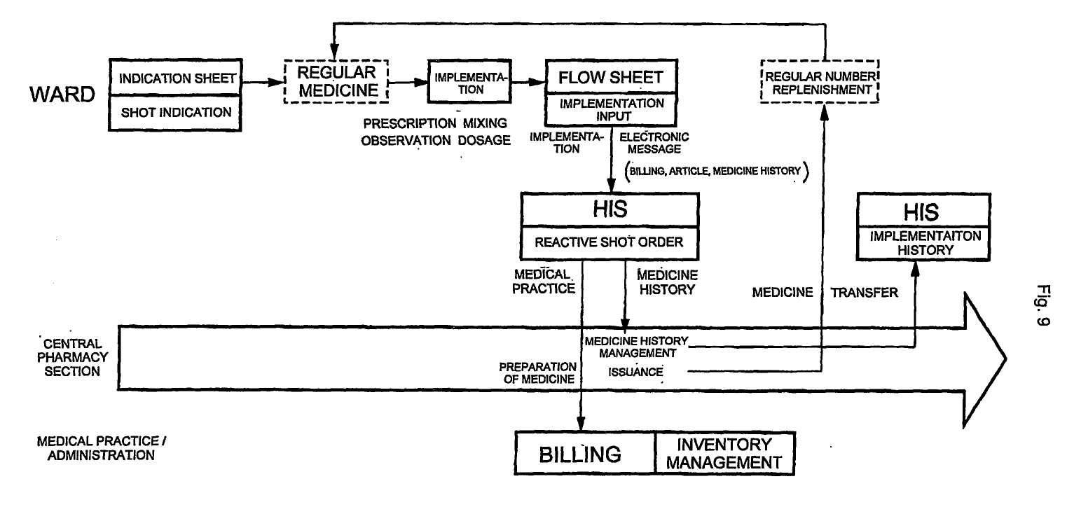

In the case of a conventional ordering system, once an order is issued, it is not possible to cancel the order for reasons related to the system functions even if the order receiving side (pharmacy section) has performed no action on the order and is in a condition to cancel the order. The hospital information system of the present invention adopts an ordering system as shown in FIG. 9 and thereby makes it possible to cancel orders in the indication sheet and minimize waste.

This ordering system provides an indication on the indication sheet, then implements an order and performs implementation input in the flow sheet. Then, the order is created in a reactive fashion and a medicine is requested. For this reason, it is possible to change the indication content until the implementation input is performed on the flow sheet. Therefore, it is possible to avoid an already ordered medicine from being returned due to a change to the indication. Thus, this function can correspond with change or suspension indications which frequently occur in an acute stage or serious stage such as ICU/NICU.

That is, since the indication sheet is linked with the flow sheet, the flow sheet is updated with an indication change by the doctor in real time. This can speed up the change of an order of a medicine. Furthermore, the ability to update the flow sheet with an indication change by the doctor in real time makes it possible to adopt a procedure for billing for the medicine actually used after the implementation and prevent useless billing.

(3) Indication Preset Function this Function Provides Presets of an Indication Content Such as a Basic Medicine, Auxiliary Medicine and Route Beforehand and Selecting a Preset on the Indication Sheet can Improve the Efficiency of Indications Such as Basic Medicine, Auxiliary Medicine and Route, Etc.

The preset patterns of a basic medicine, auxiliary medicine and route, etc., are stored in the medicine database 42. Then, selecting a pattern from the indication sheet on the PC 12 allows pattern information to be transferred from the medicine database 42 and displayed on the indication sheet Furthermore, selecting a pattern causes the timing of administration according to the pattern to be displayed on the flow sheet from the start time using marks, etc.

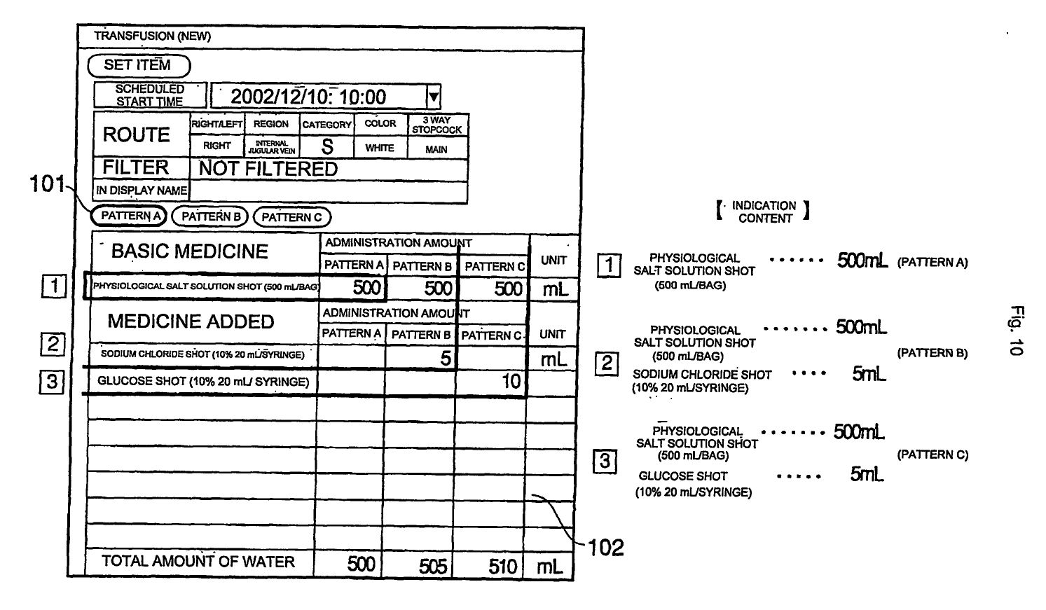

FIG. 10 illustrates the preset function of the hospital information system according to this embodiment of the invention. In FIG. 10, the system is set so as to be able to select three patterns, but the number of patterns is not limited to this and the system may also be set so as to be able to select two or four or more patterns.

When a new medicine is input on the indication sheet, the screen shown in FIG. 10 appears and shows a scheduled start time, route, use/disuse of a filter, IN display name and a pattern selection button 101. Furthermore, a medicine display field 102 is provided below the pattern selection button 101, which shows a medicine and administration amount for each pattern. This information is stored in the medicine database 42. As is clear from FIG. 10, according to pattern A only a shot of a physiological salt solution is administered, according to pattern B shots of a physiological salt solution and sodium chloride are administered and according to pattern C shots of a physiological salt solution and glucose are administered. The doctor selects a desired pattern from these patterns by clicking on the pattern selection button 101. When the basic medicine is the same and additional medicine (auxiliary medicine) is changed, a administration pattern can be indicated easily in this way.

On the screen in FIG. 10, it is possible to input a administration rate or administration order (e.g., pattern A→pattern B→pattern C). At this time, when the administration rate is entered, the administration count is calculated automatically. A formula for calculating the administration count from the administration rate is also stored in the medicine database 42.

Furthermore, when the name of a new medicine is inputted on the screen shown in FIG. 10, if a search mode is set, a search field appears. Here, a setting is made so that it is only when, for example, three letters are input in the medicine name search field that the medicine name is displayed. This prevents indication errors.

(3) Message Function of Notifying a New Indication or a Change of Indication Content

When a new indication, change or suspension of an indication is produced, the indication or the change is inputted from the operating section 61 of the PC 12. This indication or change is sent to the information registration section 48 through the data receiving and transmitting section 64 and data receiving and transmitting section 51 of the hospital information system managing center 11 and the information is updated. This updated information is acquired through the data receiving and transmitting section 64 of the PC 12 from the data receiving and transmitting section 51 and reflected in the indication sheet and flow sheet on the screen of the display 63. By displaying such a message, it is possible to send a message showing indication issuance or indication reception, for example, a message to urge a check of an indication content when a new injection indication is issued or when a change is made to an already issued indication content.

In this case, when an indication change or a new indication occurs and a message is notified, it is possible to notify the message to people concerned more speedily and reliably by blinking the changed indication or new indication on the indication sheet or flow sheet or issuing an alarm.

(4) Function of Updating the Indication Sheet with the Implementation Result Inputted on the Flow Sheet

When a nurse who implements an indication from a doctor inputs a first implementation result on the flow sheet displayed on the PC 12 using the operating section 61, the data is registered in the information registration section 48 from the data receiving and transmitting section 64 through the data receiving and transmitting section 51 of the hospital information system managing center 11. Then, the registered data is sent from the information registration section 48 to the display controlling section 62 from the data receiving and transmitting section 64 of the PC 12 through the data receiving and transmitting section 51 and the name of the implementer and implementation time are displayed in the implementer field of the bottle managing area on the indication sheet on the display 63.

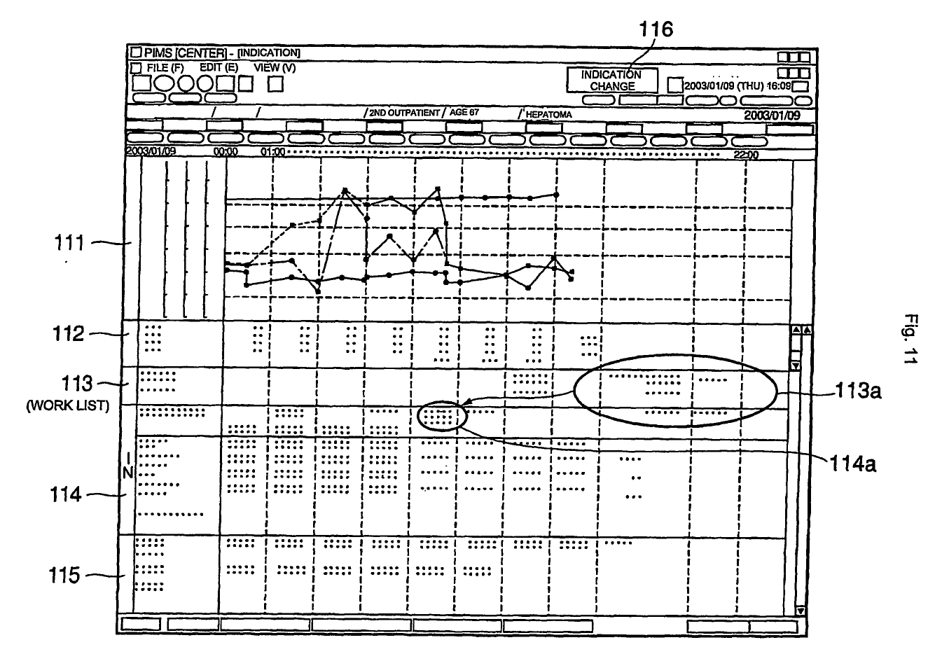

FIG. 11 is a view showing a flow sheet in the hospital information system according to this embodiment of the invention. This flow sheet mainly includes a vital sign graph area 111 showing a variation in a vital sign value, a monitor value area 112 showing monitor values of various parameters, a work list area 113 showing a schedule of medical practices to be carried out, an IN area 114 showing medicines to be administered to the patient and an OUT area 115 showing an amount of urine, amount of hemorrhage or amount of drain, etc. These display items and their layout are not limited to those in FIG. 11 and can be modified in various ways.

In the vital sign graph area 111, monitored vital sign values are plotted. This makes it possible to visually recognize a time variation of the vital sign value. Furthermore, the monitor value is displayed in the monitor value area 112. The work list area 113 shows a medical practice 113a to be applied to the patient, for example, a shot medicine, prescription (medicines for internal use/for external application) based on the indication by the doctor on the indication sheet and inspection scheduled at the own section, etc.

Clicking on the medicine name scheduled to be implemented in the work list shows an implementation input screen. Inputting the implementation time and the actual administration amount on the implementation input screen and confirming them causes the name of the medicine and a administration amount 114a to be displayed in the administration time cell in the shot field of the IN area 114, for example. Furthermore, the IN area 114 shows the medicine name indicated as a persistent medicine and clicking on an arbitrary time cell of the medicine name allows the administration amount at the relevant time to be inputted.

Here, the work list has the function of displaying and inputting the implementation of an indication at a scheduled implementation time. For example, when the indication information from the doctor is an indication having scheduled implementation time information (shot-based medicine, regular inspection, regular treatment, etc.), a scheduled implementation time is input on the indication input screen when an indication is issued on the indication sheet. At this time, indication information is displayed (work list display) at the scheduled implementation time on the flow sheet.

At the scheduled implementation time, the nurse implements the indication according to the work list. Then, the nurse starts an implementation input screen from the indication information displayed and records the implementation. The result is recorded as already having been implemented on the indication sheet again.

Clicking on the scheduled implementation name in the OUT area 115 shows an implementation input screen. Inputting the time of implementation and actual amount on the implementation input screen and confirming them shows amounts, etc., at the implementation time cell of the OUT area 115. On the flow sheet, it is possible to output an inspection order for a specimen such as blood and gas and display information on the time-varying inspection result of the issued inspection order.

When the above described indication change occurs in the flow sheet shown in FIG. 11, an indication change button 116 blinks. Then, clicking on this indication change button 116 changes the screen to an indication sheet and the above described indication reception is performed on the indication sheet. It is also possible to display a screen change button on the screen and click on the button to change the screen from the flow sheet to the indication sheet.

(5) Function of Automatically Calculating a Medical Accounting Unit Price Such as the Number of Bottles or Ampoules Actually Used Based on Chronological Record and Sending the Number to the Medical Matters Section System

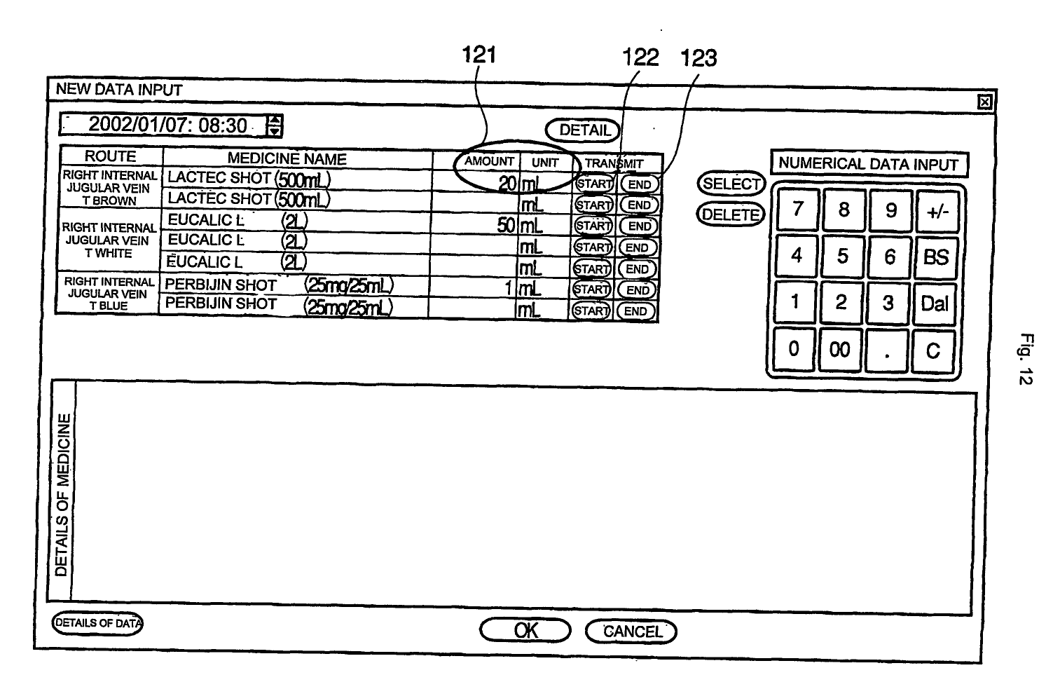

When the implementer clicks on the name of a medicine scheduled to be implemented in the work list, an input screen as shown in FIG. 12 is displayed. At this time, the medicine name field displays information on the medicine indicated by the doctor. Moving the cursor to the medicine name shows detailed information of the medicine. Then, when starting implementation, the nurse inputs a used amount (administration amount) in a used amount field 121 and clicks on a start button 122. Furthermore, the nurse confirms the time of implementation. This causes the medicine name and administration amount 114a to be displayed at a administration time cell of the IN area 114.

When the bottle is replaced or administration of the medicine is completed, the nurse clicks on the IN area 114. At this time, an input screen shown in FIG. 12 appears. Here, the nurse inputs the amount of the medicine actually used in the used amount field 121. Then, the nurse clicks on an end button 123. When the end is confirmed, information for billing is sent, a confirmation screen is displayed and if the end is not confirmed, the nurse clicks on a cancel button.

At this timing, the amount of each medicine requested is calculated from the total administration amount of the medicine from the start to the end. When the end is confirmed, the information on the total administration amount is sent from the PC 12 to the bottle number calculating section 50 of the hospital information system managing center 11.

The bottle number calculating section 50 calculates a unit price (bottle number) such as ampoules and bottles from the used amount, For this calculation, a preset calculation formula stored in the memory 50a is used. This calculation formula is established taking into account the case of a so-called divided order where the content of one bottle is divided into a plurality of portions and used a portion at a time. The information on the unit price obtained in this way is sent to the medical amount billed calculating section 49.

The medical amount billed calculating section 49 calculates a medical amount billed from the unit price. For this calculation, for example, a fee table stored in the memory 49a is used. Furthermore, depending on the hospital, accounting may be closed at a certain time to be resumed on the next day. In such a case, it is therefore desirable to calculate using a preset calculation formula to prevent omissions in billing or overcharge. The information on the medical amount billed obtained in this way is sent to the medical matters section system and pharmacy section system and used as information for medical accounting processing and replenishment of ICU medicines.

This makes it possible to reduce the amount of counting processing which used to be complicated. Furthermore, making this processing electronic prevents mix-ups between slips, etc. This also eliminates the need for conventional double recording on indication sheets and slips and improves the efficiency of operations.

When nurses, etc., carry out implementation, a barcode of a wrist band worn by a patient is compared with a barcode attached to a medicine administered to the patient to confirm that they match, the medicine name, contents prepared, etc., are checked, then the input start button is clicked and a administration amount per a unit time is input. This prevents administration errors.

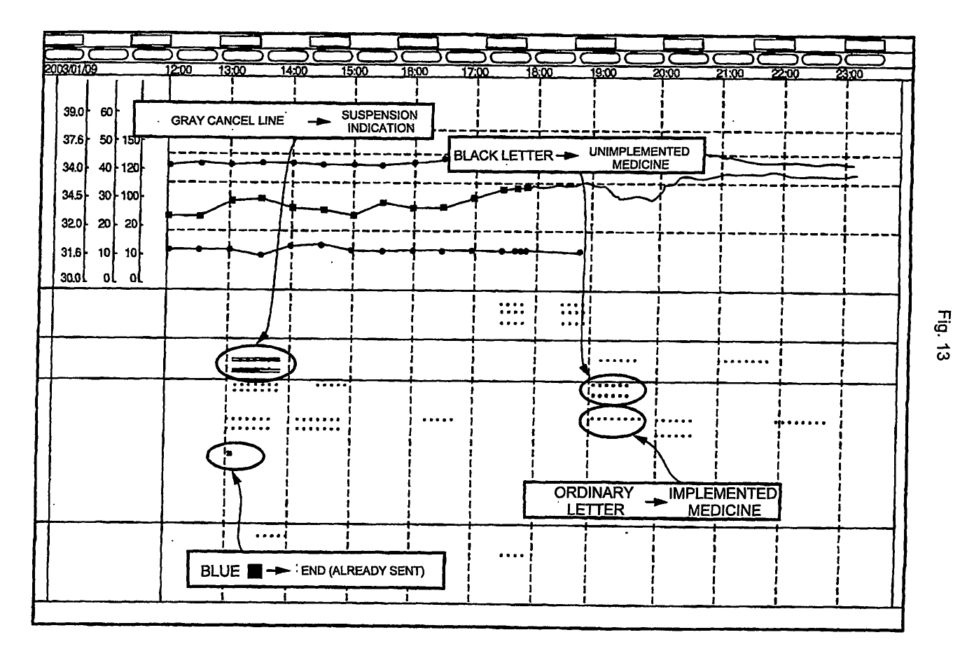

FIG. 13 is a view showing a flow sheet in the hospital information system according to this embodiment of the invention. FIG. 13 shows a case where the condition is expressed using the type of letters shown in the flow sheet. For example, ordinary letters show that the implementation has already been performed and black letters show that the implementation has not been performed yet. This allows the nurses who see the flow sheet to know at a glance whether the indication has been implemented or not. Furthermore, a gray cancel line indicates a suspension indication. In this way, by leaving the display before the indication change, it is possible to check the change history of an indication. It is preferable not to make a distinction by the color of letters but by the font of letters so that it is possible to express with more emphasis whether the indication has been implemented or not or the degree of importance.

Furthermore, when the end button is clicked on the implementation input screen after the implementation is completed, a blue ▪ mark is displayed on the flow sheet. This makes it possible to confirm whether the implementation is completed or not.

The color, font of letters and marks in FIG. 13 are just some examples and any other color, font of letters and marks, etc., may also be used if it is at least possible to distinguish on the flow sheet whether the indication has been implemented or whether the indication has been changed or whether the implementation has been completed or not.

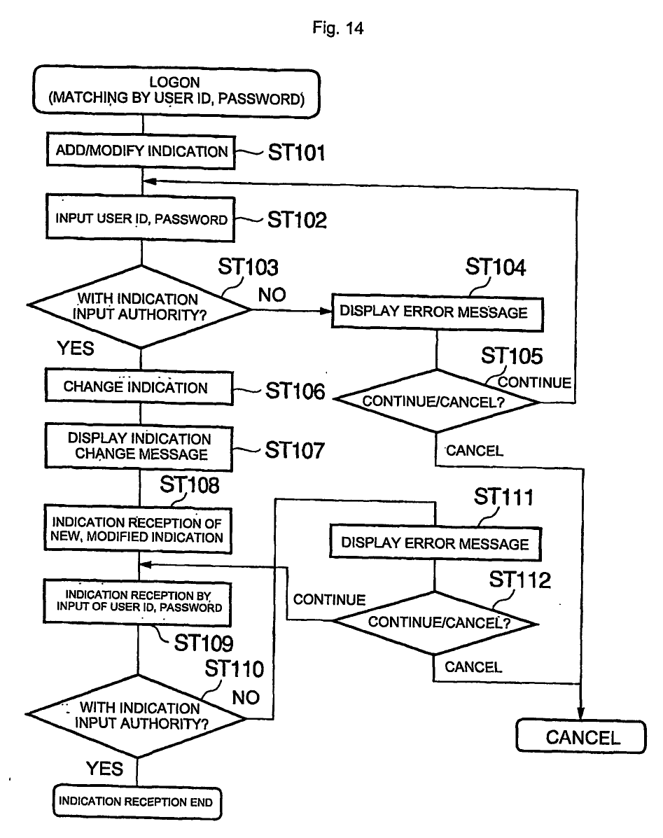

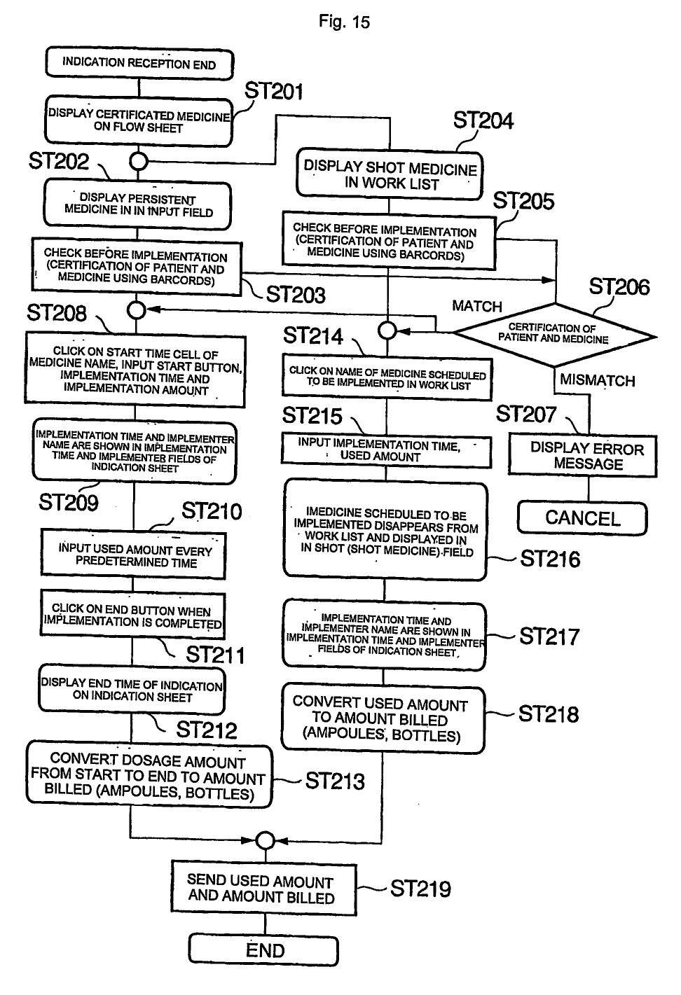

The procedure from an indication by the doctor to reception and implementation of the indication by the nurses in the hospital information system of the present invention will be explained using FIG. 14 and FIG. 15. FIG. 14 is a flow chart illustrating a procedure until an indication is received in the hospital information system according to this embodiment of the invention. FIG. 15 is a flow chart illustrating a procedure after an indication is received until the indication is implemented in the hospital information system according to this embodiment of the invention.

When the doctor provides an indication by logging on the hospital information system, user identification is performed using a user ID and password. First, when the doctor adds or modifies an indication (ST101), an input screen for the user ID and password is displayed on the indication sheet. When the doctor inputs the user ID and password (ST102), the matching section 44 of the hospital information system managing center 11 compares the user ID and password stored in the PC 12 with the user ID and password stored in the user information database 41 and determines whether the user has the authority to input the indication or not (ST103). When the user ID and password do not match and the doctor who input them does not have the authority to input, an error message is displayed (ST104) and a display as to whether the input should be continued or canceled is shown (ST105). When the input is continued, the doctor inputs the user ID and password again.

When the doctor has the input authority, the doctor changes the indication (ST106). When the indication is changed, the information is registered in the information registration section 48. Furthermore, when this information is registered, a control signal is sent to the PC 12 and a message indicating a change of the indication is displayed on the flow sheet (ST107).

When a message indicating the change of the indication is displayed on the flow sheet (see FIG. 11), the nurse receives a new indication or modification indication on the indication sheet (ST108). At this time, the input screen for the user ID and password is displayed on the indication sheet. When the nurse inputs the user ID and password (ST109), the matching section 44 of the hospital information system managing center 11 compares the user ID and password of the nurse inputted to the PC 12 with the user ID and password stored in the user information database 41 and determines as to whether the nurse has the input authority or not (ST110). Then, when the user ID and password do not match and the nurse who input them has no input authority, an error message is displayed (ST111) and a display indicating whether the input should be continued or canceled is shown (ST112). When the input is continued, the nurse inputs the user ID and password again. Thus, by the nurse receiving a new indication or modification indication on the indication sheet, it is possible to manage information on the indication, reception of the indication and implementation of the indication all together with the indication sheet which is a kind of a browser.

Then, the procedure from the reception to implementation of an indication will be explained. The medicine name whose indication has been received is displayed on the flow sheet (ST201). At this time, when the medicine is a persistent medicine, the medicine name is displayed in the IN input field (IN area) (ST202) and when the medicine is a shot-based medicine, the medicine name is displayed in the work list (ST204). A distinction as to whether a medicine is a persistent medicine or shot-based medicine is made based on whether the indication is provided through an input of a persistent medicine or through an input of a shot-based medicine. For medicines used in a plurality of modes of use (persistent, shot-based, etc.), this distinction is actually made by the medicine distinguishing section 45 browsing the medicine database 42 about the medicine inputted. Actually, both the persistent and shot-based medicines use a common medicine master (corresponding to the above described category). In that case, by differentiating the input method on a screen for persistent medicines from a screen for shot-based medicines and adding different indication information (e.g., administration rate for persistent medicines and scheduled administration time for shot-based medicines), it is possible to provide administration indications characteristic of the respective medicines with reference to the common medicine master in the respective categories. Furthermore, in this case, there is an advantage that master maintenance is more efficient than managing masters individually.

When the nurse carries out implementation by observing the flow sheet, the nurse certificates the patient and medicine using barcodes (ST203). When the nurse reads the patient's barcode and the barcode of the medicine using a barcode reader, the implementation certificating section 46 of the hospital information system managing center 11 performs certification between the information read by the barcode reader and the information stored in the patient database 43 and determines whether the medicine can be administered to the patient or not (ST206). Then, if the two pieces of information do not match, an error message is displayed (ST207).

If the two pieces of information match, the nurse clicks on the start time cell of the medicine name on the flow sheet, clicks on the start button and inputs the implementation time and used amount from the input screen displayed (ST208). This information on the implementation time and used amount is updated in the information registration section 48 and the information is reflected in the indication sheet. That is, the implementation time is displayed in the implementation time field of the indication sheet and the implementer's name is displayed in the implementer field 86c (ST209). In this way, the nurse inputs the used amount every predetermined time on the flow sheet (ST210).

Then, when the implementation is completed, the nurse clicks on the end button (ST211). This causes the end time of the indication to be displayed on the indication sheet (ST212). At the same time, the information on the used amount of the medicine from the start to the end is sent to the bottle number calculating section 50 and the unit price is calculated there (ST213). Then, the information on the unit price is sent to the medical amount billed calculating section 49 and the medical amount billed is calculated there. The used amount and medical amount billed are sent to the medical accounting system, etc., (ST219).

In the case where the medicine is a shot-based medicine, too, when the nurse implements the indication by observing the flow sheet, the nurse performs certification on the patient and medicine using barcodes in the like manner (ST206). When the two pieces of information match, the nurse clicks on the name of the medicine scheduled to be implemented in the work list on the flow sheet (ST214) and inputs the implementation time and used amount on the input screen displayed (ST215). At this time, the medicine scheduled to be implemented disappears from the work list and appears in the shot (shot medicine) field of the IN area (ST216).

This information on the implementation time and used amount is updated in the information registration section 48 and the information is reflected in the indication sheet That is, the implementation time is displayed in the implementation time field of the indication sheet and the implementer's name is displayed in the implementer field 86c (ST217).

The information on the used amount of the medicine from the start to end is sent to the bottle number calculating section 50 and the unit price is calculated there (ST218). Then, the information on the unit price is sent to the medical amount billed calculating section 49 and the medical amount billed is calculated there. The used amount and medical amount billed are sent to the medical accounting system, etc., (ST219).

As shown above, in the hospital information system of the present invention, since the indication sheet is linked with the flow sheet, the information on the indication sheet is reflected in the flow sheet in real time, and inversely the information on the flow sheet is reflected in the indication sheet in real time. This makes it possible to correctly transmit the information on the indication sheet to the nurses who work mainly by observing the flow sheet. Furthermore, the information inputted to the flow sheet is processed electronically, which eliminates the need for the counting operation which used to be performed after implementation and it is thereby possible to improve the efficiency of operations.

Furthermore, in the hospital information system of the present invention, it is possible to order articles necessary for care for the patient such as injection, prescription, inspection, nourishment, meal, etc., and reserve inspections, etc., on the indication sheet. Especially when an indication for an injection to be actually administered to the patient such as ml/hr, μg/kg/min, mEq/kg/day, mEq/L is input, it is possible to calculate a necessary amount (number) of medicines for a certain period (e.g., one day) based on this information and order the necessary amount. Furthermore, it is also possible to input a used amount (actual administration amount) in the flow sheet and calculate the number of medicines to be used and medical amount billed which become basic data for medical accounting based on this implementation record. This reduces the amount of counting processing which used to be complicated. This makes the processing electronic and can thereby prevent mix-ups between slips, etc.

The present invention is not limited to the above described embodiment, but can be implemented modified in various ways. For example, the name of a medicine, full name, numerical values, display items in the above described embodiment are just some examples and the present invention is not limited to these and can be implemented modified in various ways. Furthermore, the layout of the display screen is also an example and the present invention can be implemented modified in various ways.

The above described embodiment has described the case where the hospital information system managing center performs data management, matching and implementation certification, a calculation of medical amount billed and calculation of the bottle number, while the PC performs inputs and displays the indication sheet and flow sheet, but the present invention can also be adapted in such a way that the PC side performs at least one of processes of matching, implementation certification, calculation of medical amount billed and calculation of the bottle number.

The above described embodiment has described the case where the hospital information system of the present invention is constructed by hardware, but the hospital information system of the present invention may also be constructed by software. In this case, any construction may be acceptable if it can at least implement the function of displaying the indication sheet and flow sheet by linking them, the inputting person matching function, implementation certification function, medical amount billed calculation function and bottle number calculation function. For example, it is also possible to store the processing program in the above described hospital information system in a ROM and run the system according to instructions from a CPU according to the program. Furthermore, it is also possible to store these programs in a computer-readable storage medium, record the program stored in this storage medium in a RAM of a computer and run the system according to the program. In such a case, operations and effects similar to those described in the above embodiment can be achieved, too.

That is, the hospital information system of the present invention includes all modes as far as the function of displaying the indication sheet and flow sheet by linking them, the inputting person matching function, implementation certification function, medical amount billed calculation function and bottle number calculation function are at least implemented.

As described above, since the hospital information system of the present invention includes display means for electronic displaying an indication sheet displayed at least an indication content of a doctor and a flow sheet displayed at least time-varying vital sign, time-varying observation and time-varying treatment on a screen, information registration means for managing information displayed on the indication sheet and information displayed on the flow sheet and controlling means for updating the flow sheet with information inputted on the indication sheet and for updating the indication sheet with information inputted on the flow sheet, it is possible to link between certificated indication contents and implementation result on a flow sheet (a sheet displaying time-varying vital signs, Intake/Output, observations and measures) by linking a doctor's indications between the indication sheet and the flow sheet which is mainly used by nurses. This makes it possible to correctly transmit necessary information to nurses.

Furthermore, after indication reception by the nurses as well as the indication from the doctor, it is possible to input an implementation amount (used amount) according to a chronological record on the flow sheet and calculate a unit price and medical amount billed based on the actual used amount, and thereby automatically send the medical amount billed to the medical matters section system based on the actual administration amount for both shot-based medicines and persistent medicines. This allows medical billing based on accurate information and prevents omissions in billing and double billing, etc.

As a result, it is possible to implement a hospital information system capable of speedily corresponding with changes of medical treatments corresponding to the condition of a disease of patients.

This application is based on the Japanese Patent Application No 2002-220846 filed on Jul. 30, 2002, entire content of which is expressly incorporated by reference herein.

### INDUSTRIAL APPLICABILITY

The present invention is applicable to a hospital information system used in acute stages such as ICU/NICU and wards for seriously ill patients, etc.

1. A hospital information system comprising:
display means for electronic displaying an indication sheet displayed at least an indication content of a doctor and a flow sheet displayed at least time-varying vital sign, time-varying observation and time-varying treatment, on a screen;
information registration means for managing information displayed on said indication sheet and information displayed on said flow sheet; and
controlling means for updating said flow sheet with information inputted on said indication sheet and for updating said indication sheet with information inputted on said flow sheet.

2. The system according to claim 1, wherein said doctor provides an indication on said indication sheet, a nurse receives said indication and/or implements said indication on said flow sheet.

3. The system according to claim 1, further comprising unit price calculating means for calculating a unit price on the basis of an amount of a used medicine after implementing said indication.

4. The system according to claim 3, further comprising medical amount billed calculating means for calculating a medical amount billed of a medicine on the basis of said amount of a used medicine or said unit price.

5. The system according to claim 2, wherein an indication of requesting a medicine included in said indication is transmitted to the other system corresponding to the input of said indication by said doctor.

6. The system according to claim 2, wherein a new indication or a change of said indication inputted by said doctor on said indication sheet is displayed on said flow sheet.

7. The system according to claim 1, wherein order information received from the other system is displayed on said indication sheet and/or said flow sheet.
